(19) United States
(12) Patent Application Publication
(10) Pub. No.: US 2025/0328655 A1
(43) Pub. Date: Oct. 23, 2025

(54) Augmenting Automated Runtime API Testing with Static Analysis

(71) Applicant: APIIRO LTD., Tel Aviv (IL)

(72) Inventors: Idan PLOTNIK, Herzliya (IL); Yonatan Eldar, Tel Aviv-Yafo (IL); Eldan Ben-Haim, Kiryat Ono (IL); Igal Kreichman, Rishon LeZion (IL)

(21) Appl. No.: 19/175,189

(22) Filed: Apr. 10, 2025

Related U.S. Application Data
(60) Provisional application No. 63/635,648, filed on Apr. 18, 2024.

(51) Int. Cl. G06F 21/57; G06F 9/54; H04L 9/40

(52) U.S. Cl. CPC G06F 21/577; G06F 9/547; H04L 63/1425; G06F 2221/033

(57) ABSTRACT

A method for developing a testing plan for API endpoints including: ingesting source code of the API for which the security findings were found; conducting or importing static analysis on the ingested source code and returning static analysis API inventory; ingesting a runtime API inventory from a runtime traffic inspection of network traffic to the API endpoints; extracting a set of features from the static analysis API inventory; extracting a set of features from the runtime API inventory; comparing features from the set of features from the static analysis API inventory with features from the set of features from the runtime API inventory; outputting matched pairs of runtime API inventory and static analysis API inventory; and generating a runtime testing plan based on the runtime API inventory augmented with the static API inventory.

This patent application claims priority from, and the benefit of, U.S. Provisional Patent Application No. 63/635,648, filed Apr. 18, 2024, which is incorporated in its entirety as if fully set forth herein.

### FIELD OF THE INVENTION

The present invention relates to runtime API testing and, more particularly, to augmenting automated runtime API testing with static analysis.

### BACKGROUND OF THE INVENTION

Automated Runtime API testing tools attempt to detect security issues in services exposed through network communication protocols. A prevalent example is testing for security issues in HTTP-based APIs, such as REST calls. To achieve that, these tools typically need to gain knowledge of implemented APIs, their expected behavior and schema (hereinafter referred to as the API inventory). Based on the inventory the testing tools can effectively devise a test plan and execute it.

Building the API inventory is often done by observing runtime traffic to the API and analyzing patterns (for example, detecting URLs that return meaningful responses and observing the payload sent in successful requests). However, in some cases merely observing runtime traffic doesn't easily lend itself to understanding the exact definition of APIs.

Some tools support ingesting a declarative specification of the API (such as an OpenAPI™ specification) which provides a more accurate inventory. However, in some cases producing, or procuring, this specification may not be feasible.

### GLOSSARY OF TERMS AS USED HEREIN

API (Application Programming Interface): A set of definitions and protocols that allow different software applications to communicate and exchange data with each other. In this context, it refers to the interfaces exposed by services over a network using HTTP.
API Inventory: A comprehensive list or catalog of all the APIs implemented by a service or system, including their definitions, expected behaviors, schemas, and other relevant attributes.
API schema: A formal specification or blueprint that describes the structure and data types of an API's requests and responses.
Runtime API Testing: The process of testing APIs while they are actively running or deployed, typically by sending requests and analyzing the responses to identify security issues or other defects.
Source Code: The human-readable instructions that make up a software program.
Data Model Definitions: Descriptions of the structure and organization of data used by the APIs, including the types, relationships, and constraints of the data elements.
Static Analysis: The process of analyzing source code or executable binaries without actually executing them. It involves examining the code structure, syntax, and semantics to identify potential issues, vulnerabilities, or patterns.
Gateway and Ingress Configurations: Settings that control how external requests are routed and managed by a service, including URL rewrite logic and other traffic management rules.
Runtime Traffic Inspection: Observing and analyzing the network traffic exchanged between clients and APIs to understand their behavior and identify patterns.
Security Findings: Issues or vulnerabilities discovered during security testing, such as SQL injection vulnerabilities or buffer overflows.
Trained Models: Machine learning models that have been trained on data to perform specific tasks, such as matching or classification. In this case, models are used to correlate static analysis data with runtime data.
URL Rewrite Logic: Rules that define how URLs are modified or redirected by a gateway or server.
Route Composition Logic: The way different parts of a request route are combined or assembled.
HTTP Method: The action to be performed on a resource, such as GET, POST, PUT, or DELETE.
SQL Injection Attack s: A type of attack where malicious SQL code is inserted into input fields to manipulate database queries.
Buffer-Overflow Tests: Tests designed to identify vulnerabilities where data exceeds the allocated buffer size, potentially causing errors or security breaches.

The terms explained heretofore are to be understood in light of the aforementioned explanations as well as in light of their use in the field of art. Where the aforementioned explanations contradict the regular use of the same term in the art, the terms are to be interpreted in light of the explanations provided above (and/or elsewhere within the body of this document).

### SUMMARY OF THE INVENTION

The present invention seeks to improve automated runtime API testing tools, by exploiting access to source code in order to form an accurate inventory of APIs. To that end, the invention enhances automated runtime API testing by leveraging static source code analysis to develop a more precise and comprehensive API inventory.

According to the present invention there is provided a method for augmenting security findings discovered by an API runtime security tool inspecting network traffic to API endpoints, the method including: ingesting source code of the API for which the security findings were found; conducting or importing static analysis on the ingested source code and returning static analysis API inventory; ingesting a runtime API inventory from a runtime traffic inspection of network traffic to the API endpoints; extracting a set of features from the static analysis API inventory; extracting a set of features from the runtime API inventory; comparing features from the set of features from the static analysis API inventory with features from the set of features from the runtime API inventory; and outputting matched pairs of runtime API inventory and static analysis API inventory.

According to further features in preferred embodiments the runtime API inventory is generated by monitoring testing tool-generated network traffic to the API endpoints.

According to still further features in the described preferred embodiments the runtime API inventory is generated by monitoring real-world network traffic to the API endpoints.

According to still further features the method further includes performing the following step before the step of comparing features, the step including: training machine learning (ML) models or procuring trained ML models wherein the procured or trained ML models are adapted to perform a matching process, the matching process including matching the set of features from the static analysis API inventory with the set of features from the runtime API inventory.

According to still further features the method further includes employing the ML models to perform the matching process.

According to another embodiment there is provided a method for developing a testing plan for API endpoints, the method including: ingesting source code of the API for which the security findings were found; conducting or importing static analysis on the ingested source code and returning static analysis API inventory; ingesting a runtime API inventory from a runtime traffic inspection of network traffic to the API endpoints; extracting a set of features from the static analysis API inventory; extracting a set of features from the runtime API inventory; comparing features from the set of features from the static analysis API inventory with features from the set of features from the runtime API inventory; outputting matched pairs of runtime API inventory and static analysis API inventory; and generating a runtime testing plan based on the runtime API inventory augmented with the static API inventory.

According to still further features the static analysis API inventory provides additional parameters not found in the runtime API inventory and wherein mutations of the additional parameters are included in the testing plan.

According to still further features the static analysis API inventory includes information about implemented controls and validations of input parameters, wherein the information is used for improving the testing plan.

According to still further features the static analysis API inventory includes specific libraries or frameworks for which corresponding vulnerability exploitation methodologies are known, and using the vulnerability exploitation methodologies to tailor the testing plan.

According to still further features the method further includes performing the following step before the step of comparing features, the step including: training machine learning (ML) models or procuring trained ML models wherein the procured or trained ML models are adapted to perform a matching process, the matching process including matching the set of features from the static analysis API inventory with the set of features from the runtime API inventory.

According to still further features the method further includes the step of: employing the ML models to perform the matching process.

### BRIEF DESCRIPTION OF THE DRAWINGS

Various embodiments are herein described, by way of example only, with reference to the accompanying drawings, wherein:

FIG. 1 is a flow diagram of a process 100 for augmenting security findings discovered by an API runtime security tool inspecting network traffic to API endpoints;

FIG. 2 is a flow diagram of an example process 200 for developing a testing plan for API endpoints, according to another embodiment of the invention.

### DESCRIPTION OF THE PREFERRED EMBODIMENTS

The principles and operation of a system and method for augmenting automated runtime API testing with static analysis of the source code according to the present invention may be better understood with reference to the drawings and the accompanying description.

As briefly discussed in the Background section, Automated Runtime API testing tools attempt to detect security issues in services exposed through network communication protocols. A prevalent example is testing for security issues in HTTP-based APIs, such as REST calls. To achieve that, these tools typically need to gain knowledge of implemented APIs, their expected behavior and schema (hereinafter referred to as the API inventory).

There are actually two general approaches or types of runtime testing:
1. API active testing/Dynamic Application Security Testing (DAST)—where the tool gains information about schema and expected behavior (as mentioned) and actively generates traffic and attempts to attack those APIs to find weaknesses and vulnerabilities in those APIs. One of the goals of the present invention is to augment or improve the knowledge base of the API inventory in order to improve, optimize, and streamline the testing plans used for active/dynamic testing.
2. API traffic monitoring, where the tool is passive and only looks at natural or real-world incoming network traffic. In this passive-type testing, there is no prior knowledge required. Rather, the tool “learns” from the live (real-world) traffic that it inspects and generates an inventory and findings from the live traffic coming in from the real world.

In both cases (active and passive testing), the system/process takes the inventory of API endpoints and findings identified by both types of tools and matches the static analysis to them.

In existing testing tools, the inventory from the runtime testing tools helps to effectively devise a test plan (for active testing) and execute it. According to some embodiments of the present invention, matching static analysis of the source code to the runtime inventory and findings enhances or augments the testing plan, resulting in better optimized and streamlined testing plans to be used in dynamic testing.

Building the API inventory is often done by observing runtime traffic to the API and analyzing patterns (for example, detecting URLs that return meaningful responses and observing the payload sent in successful requests). As mentioned above, in some cases merely observing runtime traffic does not easily lend itself to understanding the exact definitions of APIs.

For example, consider a service that implements two API endpoints: one is GET/objects/<object_id>, perhaps allowing to obtain the information about some object given its ID, and the other is GET/objects/list, possibly allowing the caller to obtain a list of objects. Clearly these are two different APIs with different expected behaviors that probably call for different test plans. However, based on runtime traffic alone, distinguishing between the two becomes non-trivial and thus is often inaccurate. Therefore, according to embodiments of the present invention, matching runtime inventory and findings to static analysis (as discussed in further detail below) improves, inter alia, the knowledge base (or accuracy) of the API inventory and thus allows, for example, improved plans for active API testing, and hence returns better results.

Some tools support ingesting or incorporating declarative specifications of the APIs which provide a more accurate inventory. However, in some cases producing or procuring this specification may not be feasible. Moreover, in some cases (see some examples below), even when an API specification is available, e.g., from OpenAPI™, the information gathered through static analysis can still greatly enhance testing optimization.

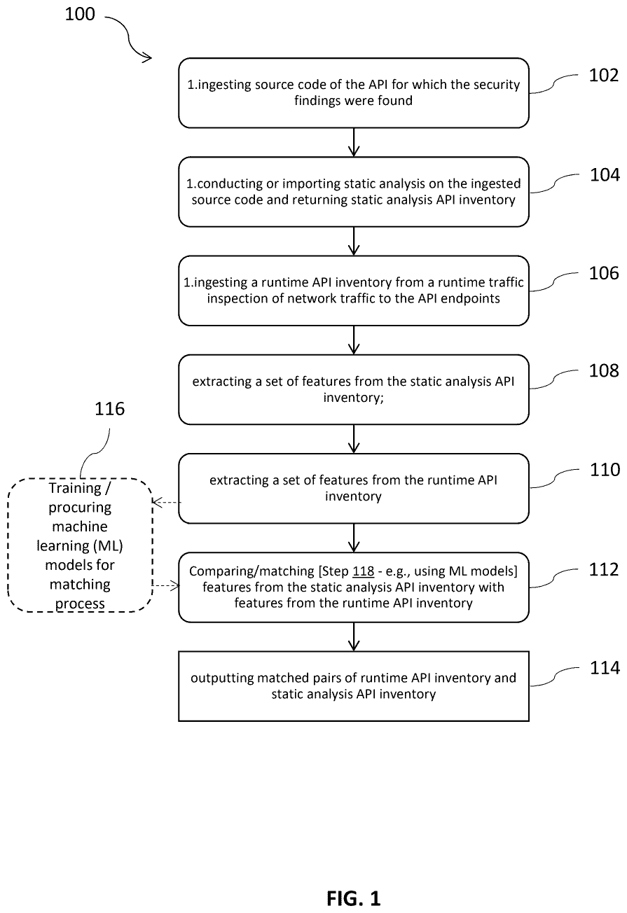

FIG. 1 illustrates a flow diagram of a process 100 for augmenting security findings discovered by an API runtime security tool inspecting network traffic to API endpoints. The present invention successfully addresses the shortcomings of the presently known configurations by providing a reference from each API endpoint or finding identified by the runtime tool to the location of the code that is handling that request. Correlating the API endpoint or security finding to the location in the source code is achieved by a matching process that is detailed hereafter. Being able to match an API endpoint or security finding to the source code for the same allows locating the source of the problem for a finding, history of changes to the logic and association to the relevant code contributors using git history of the code.

The process includes the following steps:
Step 102: Source code of the API for which the aforementioned security findings were found is ingested.
Step 104: Static analysis is conducted on the ingested source code. In some cases, the static analysis may be performed by a third party. In such cases, the static analysis is imported from that third party. Goals of the static analysis include, but are not limited to, identifying one or more of: API definitions, data models, and other relevant attributes (including, for example, authorship of the code, history of changes made to the code, behavioral analysis of the code author, etc.). Additionally, gateway and ingress configurations are gathered (identified, collated, and stored) to determine, for example, URL rewrite logic. The API inventory of the static analysis is referred to herein as the static analysis API inventory.
Step 106: The system ingests an inventory of API endpoints discovered by tools inspecting runtime traffic and security findings found for those endpoints, hereafter referred to as a runtime API inventory.
Step 108: A set of features is extracted from the static analysis-based inventory and, in Step 110, a second set of features is extracted from runtime-based inventories. These features include hostname, HTTP method, request route, query and route parameter schemas, request and response body schemas, API method signatures, route rewrite logic, and route composition logic.
Step 112: Compare and match features from the set of static analysis-based inventory features and the set of runtime-based inventory features.
Step 114: Return as output the matched pairs of runtime API inventory and static analysis API inventory.

According to some embodiments, the following step (Step 116) is performed before Step 112:
Step 116: Train Machine Learning (ML) models or procure trained ML models. The procured or trained ML models are adapted to perform a matching process. The matching process includes matching the set of features from the static analysis API inventory with the set of features from the runtime API inventory.
Step 118: Employ ML models to perform the matching process of Step 112 to identify the most likely correlations between the source code and runtime inventories.

In some embodiments, the runtime API inventory is generated by monitoring testing tool-generated network traffic to the API endpoints.

In some embodiments, the runtime API inventory is generated by monitoring real-world network traffic to the API endpoints.

There are various advantages to matching the code to the runtime API. One important advantage is that the information gained from the matching process can be used to improve security testing. This advantage is discussed in much detail below with regards to the embodiment of developing an improved testing plan for active testing/DAST of API endpoints.

Some additional advantages include, but are in no way limited to:
The ability to see the direct implementation location behind the endpoint.
Reviewing and/or fixing security findings identified for the endpoint.
Identifying the contributor who implemented the code.
Being able to see the change history of the API.

Various additional advantages would become evident to one skilled in the art in view of the present disclosure.

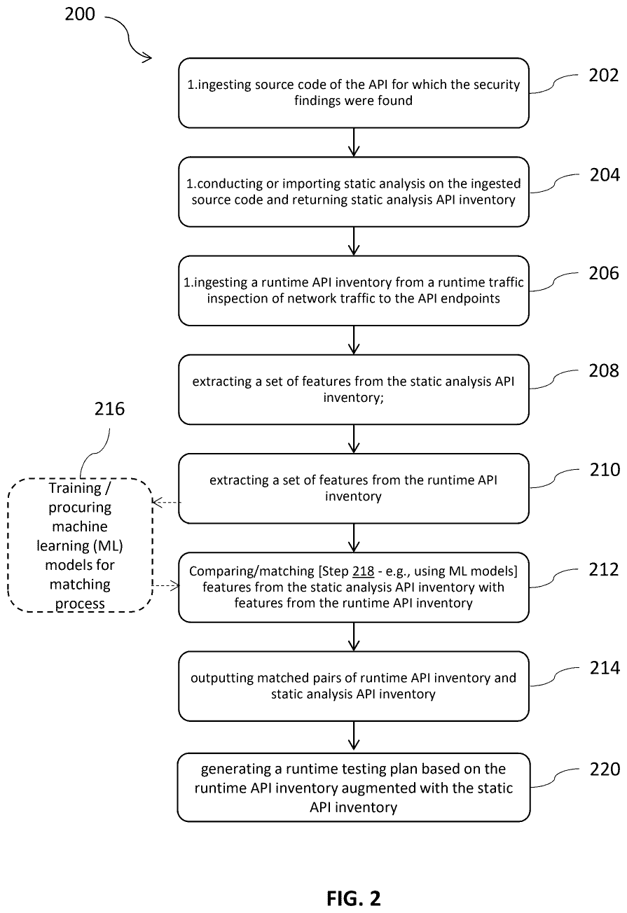

FIG. 2 illustrates a flow diagram of an example process 200 for developing a testing plan for API endpoints, according to another embodiment of the invention. One of the objectives of the present invention is to improve automated runtime API testing tools. In embodiments of the invention, such improvement is achieved using one or more processes which exploit access to source code (e.g., as detailed with reference to process 100) in order to form an accurate inventory of the APIs. The augmented/optimized/more detailed API inventories are used to improve, optimize and streamline testing plans for active testing/DAST.

One example embodiment of a process for developing a testing plan for API endpoints is detailed below in process 200. Process 200 includes the following steps:
Step 202: (Steps 202-218 are similar to steps 102-118 from process 100 detailed above. It is to be understood that any details mentioned above with reference to process 100 apply mutatis mutandis to process 200, and vice versa.) Ingest source code used to implement the tested services. In some cases, object-code or other executable binary representation may also be used. However, in the latter option, many of the improvements mentioned elsewhere herein (such as code history and association back to the relevant contributor of the code) are, or may be, lost.
Step 204: Perform static analysis on the artifacts above in order to identify attributes such as API definitions, data model definitions, usage of specific frameworks, APIs, databases etc. When referring to source code, the artifacts may refer to, for example, “binaries” or “libraries” containing the compiled source code. The API inventory returned from the analysis is referred to herein as static analysis API inventory. The static analysis or product thereof may be performed by a third party and imported by the system.
Step 206: Ingest a runtime API inventory generated from a runtime traffic inspection of network traffic to the API endpoints.
Step 208: Extract a set of features from the static analysis API inventory, as above.
Step 210: Extract a set of features from the runtime API inventory, as above.
Step 212: Compare features from the set of features from the static analysis API inventory with features from the set of features from the runtime API inventory.
Step 214: Output matched pairs of runtime API inventory and static analysis API inventory, as above.
Step 216: Optionally, Train Machine Learning (ML) models or procure trained ML models, prior to step 214. The procured or trained ML models are adapted to perform a matching process. The matching process includes matching the set of features from the static analysis API inventory with the set of features from the runtime API inventory.
Step 218: Employ the ML models to perform the matching process of step 214.
Step 220: Based on the API definitions and the additional attributes, devise a tailored test plan. To this end, a runtime testing plan is generated based on the runtime API inventory augmented with the static API inventory wherein the static API inventory includes information not found in the runtime API inventory.

The information that can be potentially obtained on the APIs from static analysis is ample and serves to better the testing process in multiple ways. Some examples:
1. API definitions obtained through static analysis will be more accurate than those obtained by observing runtime traffic. To continue the example above, the two GET APIs are typically declared separately in code (and also implemented in separate object code) and thus the system can distinguish between them and identify each of them individually. In addition, static analysis can help identify additional parameters that can be passed to the API method, which might be missed by tools only leveraging traffic inspection. When devising a testing plan, the testing tool will usually only try to mutate values of parameters that were observed previously when monitoring the network traffic. With additional parameters from the static analysis API inventory, the testing tools now have more parameters from which to create mutations. These additional mutations are now also used in the active testing. On top of that, static analysis can provide some information about the implemented controls and validations of input parameters, which can focus the testing tool on which mutations to try for simulated attacks or how to generate valid requests.
2. Data model definitions can contribute to understanding the expected behavior of the APIs; furthermore, the way they are implemented may highlight interesting tests (for example, in a C++-based implementation, a data model object that contains a fixed-length buffer can be a good target for buffer-overflow tests).
3. Detection of use of an SQL database in the execution flow of an API endpoint can indicate it would be beneficial to attempt SQL injection attacks.
4. Detection of usage of specific libraries and frameworks may hint at testing for known vulnerabilities in these frameworks. There exists publicly available information (libraries, databases) about vulnerability exploitation methodologies. Once libraries and frameworks are identified, the corresponding known methodologies are used to further tailor the testing plan, adjusting the attempted attacks to the actually called framework, specific version of the framework and the specifically invoked methods of the vulnerable framework.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit, e.g. GPUs, to train and run the models in steps 116, 118, 216, and 218. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for

executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable non-transitory storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes and is not intended to limit any of such computer-implemented methods disclosed herein.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A method for augmenting security findings discovered by an API runtime security tool inspecting network traffic to API endpoints, the method comprising:
ingesting source code of the API for which the security findings were found;
conducting or importing static analysis on the ingested source code and returning static analysis API inventory;
ingesting a runtime API inventory from a runtime traffic inspection of network traffic to the API endpoints;
extracting a set of features from the static analysis API inventory;
extracting a set of features from the runtime API inventory;
comparing features from the set of features from the static analysis API inventory with features from the set of features from the runtime API inventory; and
outputting matched pairs of runtime API inventory and static analysis API inventory.

2. The method of claim 1, wherein the runtime API inventory is generated by monitoring of testing tool-generated network traffic to the API endpoints.

3. The method of claim 1, wherein the runtime API inventory is generated by monitoring real-world network traffic to the API endpoints.

4. The method of claim 1, further including performing the following step before the step of comparing features, the step comprising:
training machine learning (ML) models or procuring trained ML models wherein the procured or trained ML models are adapted to perform a matching process, the matching process including matching the set of features from the static analysis API inventory with the set of features from the runtime API inventory.

5. The method of claim 4, further comprising the step of:
employing the ML models to perform the matching process.

6. A method for developing a testing plan for API endpoints, the method comprising:
ingesting source code of the API for which the security findings were found;
conducting or importing static analysis on the ingested source code and returning static analysis API inventory;
ingesting a runtime API inventory from a runtime traffic inspection of network traffic to the API endpoints;
extracting a set of features from the static analysis API inventory;
extracting a set of features from the runtime API inventory;
comparing features from the set of features from the static analysis API inventory with features from the set of features from the runtime API inventory;
outputting matched pairs of runtime API inventory and static analysis API inventory; and
generating a runtime testing plan based on the runtime API inventory augmented with the static API inventory.

7. The method of claim 6, wherein the static analysis API inventory provides additional parameters not found in the runtime API inventory and wherein mutations of the additional parameters are included in the testing plan.

8. The method of claim 6, wherein the static analysis API inventory includes information about implemented controls and validations of input parameters, wherein the information is used for improving the testing plan.

9. The method of claim 6, wherein the static analysis API inventory includes specific libraries or frameworks for which corresponding vulnerability exploitation methodologies are known, and using the vulnerability exploitation methodologies to tailor the testing plan.

10. The method of claim 6, further including performing the following step before the step of comparing features, the step comprising:
training machine learning (ML) models or procuring trained ML models wherein the procured or trained ML models are adapted to perform a matching process, the matching process including matching the set of features from the static analysis API inventory with the set of features from the runtime API inventory.

11. The method of claim 10, further including the step of:
employing the ML models to perform the matching process.
